(19) United States
(12) Patent Application Publication
(10) Pub. No.: US 2026/0327372 A1
(43) Pub. Date: Oct. 22, 2026

(54) ELECTROPHOTOGRAPHIC CLEANING BLADE, PROCESS CARTRIDGE, AND ELECTROPHOTOGRAPHIC IMAGE FORMING APPARATUS

(71) Applicant: CANON KABUSHIKI KAISHA, Tokyo (JP)

(72) Inventors: SHOTA SEGAWA, Shizuoka (JP); MASANORI YOKOYAMA, Shizuoka (JP); YOSHITAKA SUZUMURA, Shizuoka (JP)

(21) Appl. No.: 19/648,095

(22) Filed: Apr. 15, 2026

(30) Foreign Application Priority Data
Apr. 22, 2025 (JP) 2025-070329

(51) Int. Cl. C08G 18/83; C08J 7/16; G03G 21/00; G03G 21/18

(52) U.S. Cl. CPC C08G 18/833; C08J 7/16; G03G 21/0017; G03G 21/1814; C08J 2375/06

(57) ABSTRACT

An electrophotographic cleaning blade comprising an elastic member and a support member that supports the elastic member, wherein the elastic member is composed of a polyurethane having a urethane group; at least one surface of the elastic member has a cured layer obtained by the impregnating polyurethane with an aromatic isocyanate and curing the same; the cured layer has uretdione group formed by uretdionization of the aromatic isocyanate, and in FT-IR measurement of the surface of the cured layer using diamond as an ATR crystal, a value Ia/Ib of a peak intensity ratio of a peak intensity Ia of a carbonyl stretching vibration (vC=O) derived from the uretdione group to a peak intensity Ib of a NH bending vibration (δNH) derived from the urethane group is at least 0.300.

### BACKGROUND

### Field of the Technology

The present disclosure relates to an electrophotographic cleaning blade for use in electrophotographic image forming apparatuses, a process cartridge, and an electrophotographic image forming apparatus.

### Description of the Related Art

In electrophotographic image forming apparatuses, a cleaning member is provided to remove residual toner remaining on the surface of an image bearing member, such as a photosensitive member, or an intermediate transfer body after a toner image has been transferred from the image bearing member or intermediate transfer member onto a transfer target member. Hereinafter, the image bearing member and the intermediate transfer member are also referred to as a member to be cleaned. One of the cleaning members used for cleaning is an electrophotographic cleaning blade.

Electrophotographic cleaning blades are mainly manufactured from polyurethanes. However, when using conventional cleaning blades made of polyurethanes, the coefficient of friction between the polyurethane and the member being cleaned is large, which can cause the cleaning blade to curl and break.

In contrast, Japanese Patent Laid-Open No. 2007-052062 discloses a surface-hardened blade in which the surface of the cleaning blade is impregnated with isocyanate to achieve high hardness and low friction at the contact portion contacting with the member being cleaned. This surface-hardened blade is prevented from curling and provides favorable cleaning performance.

In recent years, there has been a demand for further improvements in printing speed and longer service life of electrophotographic image forming apparatuses. For improved printing speed and longer service life, an electrophotographic cleaning blade is required that can achieve high-level cleaning performance over a long period of time, even when the member to be cleaned is driven at high speed.

However, the present inventors have recognized that surface-hardened blades, such as those described in Japanese Patent Laid-Open No. 2007-052062, may experience wear on the contact surface during high-speed operation and long-term use, leading to a decrease in cleaning performance and to contamination of a charging roller as the number of printed pages increases.

### SUMMARY

Therefore, there is a need for an electrophotographic cleaning blade that can stably exhibit excellent cleaning performance even in high-speed systems and for a long period of time. The present disclosure provides an electrophotographic cleaning blade that is resistant to wear even in high-speed systems and during long-term use, and can exhibit excellent cleaning performance for a long period of time. The present disclosure also provides a process cartridge and an electrophotographic image forming apparatus having the above-mentioned electrophotographic cleaning blade.

The present disclosure relates to an electrophotographic cleaning blade including an elastic member and a support member that supports the elastic member, wherein the elastic member is composed of a polyurethane having a urethane group; at least one surface of the elastic member has a cured layer obtained by impregnating the polyurethane with an aromatic isocyanate and curing the same; the cured layer has uretdione group formed by uretdionization of the aromatic isocyanate, and in FT-IR measurement of the surface of the cured layer using diamond as an ATR crystal, a value Ia/Ib of a peak intensity ratio of a peak intensity Ia of a carbonyl stretching vibration (vC=O) derived from the uretdione group to a peak intensity Ib of a NH bending vibration (δNH) derived from the urethane group is at least 0.300.

Also, the present disclosure relates to a process cartridge including the electrophotographic cleaning blade.

Also, the present disclosure relates to an electrophotographic image forming apparatus including the electrophotographic cleaning blade.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic perspective view of an electrophotographic cleaning blade.

FIG. 2 is a diagram showing the state in which the edge of the cleaning blade is in contact with the member being cleaned when a process cartridge is stationary,

FIG. 3 is a diagram illustrating a method for observing the wear state.

### DESCRIPTION OF THE EMBODIMENTS

In the present disclosure, unless otherwise specified, the expressions “from XX to YY” or “XX to YY” representing a numerical range refer to a numerical range that includes both the lower and upper limits. When a numerical range is stated in stages, the upper and lower limits of each numerical range can be arbitrarily combined. Furthermore, in the present disclosure, a statement such as “at least one selected from the group consisting of XX, YY, and ZZ” means any of XX, YY, ZZ, a combination of XX and YY, a combination of XX and ZZ, a combination of YY and ZZ, or a combination of XX, YY, and ZZ. When XX is a group, multiple members may be selected from XX, and the same applies to YY and ZZ.

Examples of the member to be cleaned to which the electrophotographic cleaning blade (hereinafter also simply referred to as “cleaning blade”) according to one aspect of the present disclosure can be applied include image bearing members such as photosensitive members, and endless belts such as intermediate transfer belts. Below, an embodiment of the cleaning blade according to one aspect of the present disclosure will be described in detail using an image bearing member as an example of the member to be cleaned, but the present disclosure is not limited thereto. Furthermore, in the following description, components having the same function are given the same reference number in the drawings, and descriptions thereof may be omitted.

### Configuration of the Cleaning Blade

The cleaning blade comprises an elastic member and a support member that supports the elastic member. The cleaning blade cleans the surface of a moving member to be cleaned by bringing a part of the elastic member into contact with the surface of the member to be cleaned. The elastic member is composed of a polyurethane having a urethane group, and at least one surface of the elastic member has a cured layer obtained by impregnation with an aromatic isocyanate and curing. The cured layer has uretdione groups formed by uretdionization of the aromatic isocyanate. For example, the elastic member has a cured layer at the contact portion with the member to be cleaned. That is, at least a part of the cured layer is the contact portion with the member to be cleaned.

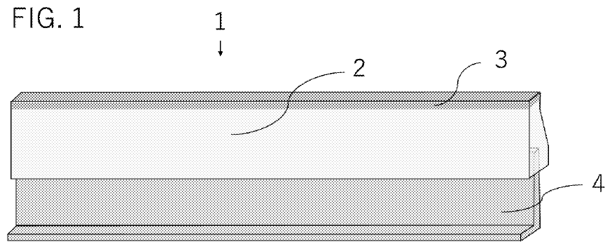

FIG. 1 is a schematic perspective view of a cleaning blade 1 according to one aspect of the present disclosure. The cleaning blade 1 comprises an elastic member 2 and a support member 4 that supports the elastic member 2, and has a cured layer 3 at the tip of the elastic member 2.

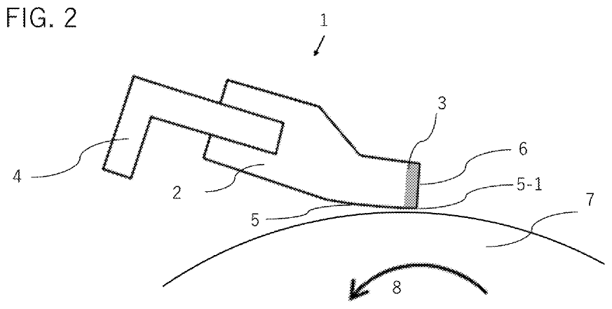

FIG. 2 is an example schematically showing, in a cross-sectional view, a state in which the cleaning blade according to one aspect of the present disclosure is in contact with the member to be cleaned. The elastic member 2 has a main surface 5 facing the member to be cleaned 7, and a tip surface 6 that forms a tip-side edge 5-1 together with the main surface 5. Reference numeral 8 indicates the direction of rotation of the member to be cleaned.

### Uretdione Bonding

As a result of extensive research, the present inventors have found that in a cured layer formed by impregnating polyurethane with isocyanate and curing, uretdionization of the isocyanate on the surface of the cured layer enhances wear resistance, resulting in excellent cleaning performance over a long period of time. The inventors consider the reason for this to be as follows.

Due to prolonged friction between the cleaning blade and the member to be cleaned, the contact area with the member to be cleaned wears down. Three-dimensionally cross-linked polyurethane has high wear resistance and is less prone to wear, but in a cured layer formed by impregnating with isocyanate and curing, the impregnated material is thought to detach, making the cured layer susceptible to wear.

Although the impregnated material is incorporated inside the polyurethane network, it is thought that the interaction between the polyurethane skeleton and the impregnated material is insufficient, causing the impregnated material to detach due to prolonged friction. Therefore, blades obtained by impregnating with isocyanate and curing gradually wear down during long-term use. On the other hand, it is considered that by the uretdionization of the cured layer surface, the interaction between the impregnated material and the urethane skeleton is strengthened, making it less likely for the impregnated material to detach. Therefore, it is considered that the wear resistance of the cured layer is improved, and excellent cleaning performance can be obtained over a long period.

The cured layer has uretdione groups generated by the curing of aromatic isocyanate. In the FT-IR measurement of the surface of the cured layer using diamond as an ATR crystal, the peak intensity of the carbonyl stretching vibration (vC=O) derived from the uretdione group is defined as peak intensity Ia, and the peak intensity of the NH bending vibration (δNH) derived from the urethane group is defined as peak intensity Ib. At this time, it is necessary that the ratio value Ia/Ib of peak intensity Ia to peak intensity Ib be 0.300 or more. Ia/Ib is preferably 0.330 or more.

The carbonyl stretching vibration (vC=O) derived from the uretdione group shows a peak at 1755 cm⁻¹ to 1780 cm⁻¹. The NH bending vibration (δNH) derived from the urethane group shows a peak around 1530 cm⁻¹

The value Ia/Ib of peak intensity ratio represents the amount of uretdione groups relative to urethane groups on the blade surface. When Ia/Ib is 0.300 or more, the uretdione groups are present relative to the urethane groups at a level sufficient to provide an effect on wear resistance. When sufficient amount of uretdione groups is present, the interaction between the impregnated material and the urethane skeleton is strengthened, making it difficult for the impregnated material to detach from the urethane skeleton, thus improving wear resistance. Therefore, the wear resistance of the cured layer is improved, and excellent cleaning performance can be obtained for a long period of time.

There is no particular upper limit to Ia/Ib. Ia/Ib is, for example, 0.300 to 0.500, preferably 0.330 to 0.500, more preferably 0.330 to 0.400, and even more preferably 0.330 to 0.380.

Methods for increasing Ia/Ib on the surface of the impregnated cured layer include impregnating with a catalyst that has uretdionization activity simultaneously with the isocyanate being impregnated, and impregnating with an isocyanate containing a uretdione bond.

### Constituent Materials

### Support Member

The cleaning blade of the present disclosure has a support member that supports the elastic member. The material constituting the support member is not particularly limited, and examples thereof include the following materials: metal materials such as steel plates, stainless steel plates, galvanized steel plates, and chromium-free steel plates; and resin materials such as 6-nylon and 6,6-nylon.

Furthermore, the shape and structure of the support member are not particularly limited. For example, as shown in FIG. 2, one end of the elastic member 2 of the cleaning blade is supported by the support member 4.

### Elastic Member

The elastic member is composed of polyurethane having urethane groups. The polyurethane is preferably a polyurethane elastomer. The polyurethane constituting the elastic member mainly includes reaction products of urethane raw materials such as polyols, chain extenders, crosslinking agents, polyisocyanates, catalysts, and other additives.

The raw materials of the polyurethane will be described in detail below.

Examples of polyols include the following: polyester polyols such as polyethylene adipate polyol, polybutylene adipate polyol, polyhexylene adipate polyol, (polyethylene/polypropylene) adipate polyol, (polyethylene/polybutylene) adipate polyol, and (polyethylene/polyneopentylene) adipate polyol; polycaprolactone-based polyols obtained by ring-opening polymerization of caprolactone; polyether polyols such as polyethylene glycol, polypropylene glycol, and polytetramethylene glycol; and polycarbonate diols. These can be used individually or in combination of two or more.

Among the above polyols, polyester polyols using adipate are preferred because they yield polyurethanes with excellent mechanical properties. Polyester polyols using butylene adipate are more preferred. For example, commercially available products such as “Nippolan 3027 (product name, manufactured by Tosoh Corporation)” with a number-average molecular weight of 2500, and “Nippolan 4010 (product name, manufactured by Tosoh Corporation)” with a number-average molecular weight of 2000 can be used.

As the chain extender, glycols and trihydric or higher polyhydric alcohols capable of extending the polyurethane elastomer chain can be used.

Examples of the glycols include ethylene glycol (EG), diethylene glycol (DEG), propylene glycol (PG), dipropylene glycol (DPG), 1,4-butanediol (1,4-BD), 1,6-hexanediol (1,6-HD), 1,4-cyclohexanediol, 1,4-cyclohexanedimethanol, xylylene glycol (terephthalyl alcohol), and triethylene glycol.

Examples of the trihydric or higher polyhydric alcohols include trimethylolpropane, glycerin, pentaerythritol, and sorbitol. These can be used individually or in combination of two or more. It is preferable to use these trihydric or higher polyhydric alcohols as crosslinking agents. Among the above polyhydric alcohols, trimethylolpropane is more preferable.

Examples of the polyisocyanates include 4,4′-diphenylmethane diisocyanate (4,4′-MDI), polymeric MDI (pMDI), 2,4-tolylene diisocyanate (2,4-TDI), 2,6-tolylene diisocyanate (2,6-TDI), xylylene diisocyanate (XDI), 1,5-naphthylene diisocyanate (1,5-NDI), p-phenylene diisocyanate (PPDI), hexamethylene diisocyanate (HDI), isophorone diisocyanate (IPDI), 4,4′-dicyclohexylmethane diisocyanate (hydrogenated MDI), tetramethylxylylene diisocyanate (TMXDI), and carbodiimide-modified MDI.

Among the above polyisocyanates, 4,4′-MDI or polymeric MIDI, which have high reactivity and yield good mechanical properties, are preferred. The polyurethane preferably has a structure in which at least one selected from the group consisting of 4,4′-diphenylmethane diisocyanate and polymeric MDI has reacted. This structure is, for example, a structure in which at least one selected from the group consisting of 4,4′-diphenylmethane diisocyanate and polymeric MDI has undergone urethanization.

The urethane raw material may contain a prepolymer formed by the reaction of a polyol and a polyisocyanate. The prepolymer is preferably a reaction product of at least one selected from the group consisting of 4,4′-diphenylmethane diisocyanate and polymeric MDI, and the above polyester polyol.

As the catalyst, generally used catalysts for curing polyurethane elastomers can be used. Examples include tertiary amine catalysts, and specifically, the following can be exemplified. Amino alcohols such as dimethylethanolamine, N,N,N′-trimethylaminopropylethanolamine, and N,N′-dimethylhexanolamine; trialkylamines such as triethylamine; tetraalkyldiamines such as N,N,N′N′-tetramethyl-1,3-butanediamine; triethylenediamine, piperazine compounds, and triazine compounds. Metal organic acid salts such as potassium acetate and potassium octoate can also be used. Furthermore, metal catalysts commonly used in urethanization, such as dibutyltin dilaurate, can also be used. These can be used alone or in combination of two or more.

As a catalyst, N,N′-dimethylhexanolamine is preferred. Examples of commercially available products include Kaolizer No. 25 (product name, manufactured by Kao Corporation). An ethylene glycol solution of potassium acetate is also preferred. Examples of commercially available products include POLYCAT 46 (product name, manufactured by Air Products Japan Ltd.).

For example, the polyurethane preferably includes, as constituent components, at least one polyol selected from the group consisting of polyester polyols and polyether polyols, trihydric or higher polyhydric alcohol, and at least one polyisocyanate selected from the group consisting of 4,4′-MDI and pMDI.

The raw materials constituting the elastic member may optionally contain additives such as pigments, plasticizers, waterproofing agents, antioxidants, ultraviolet absorbers, and light stabilizers.

### Cured Layer

At least one surface of the elastic member has a cured layer obtained by impregnating the polyurethane with an aromatic isocyanate and curing, and the cured layer has uretdione groups formed by the aromatic isocyanate. The uretdione groups are formed, for example, by the uretdionization of the aromatic isocyanate. The cured layer is formed, for example, on the tip portion of the elastic member 2, including the tip surface 6. The cured layer is obtained by impregnating the elastic member with an aromatic isocyanate and curing. Uretdione groups are formed by the curing of the aromatic isocyanate. For example, the cured layer is a layer in which the aromatic isocyanate is impregnated in the polyurethane and uretdionized.

Furthermore, the cured layer is preferably a layer obtained by impregnating the polyurethane with an impregnation treatment agent and curing. The impregnation treatment agent contains at least an aromatic isocyanate. In addition to the aromatic isocyanate, a catalyst may be impregnated into the cured layer. These impregnating materials may be diluted with a solvent.

The impregnating materials are described in detail below.

Examples of aromatic isocyanates include at least one selected from the group consisting of 4,4′-diphenylmethane diisocyanate (4,4′-MDI), polymeric MDI (pMDI), 2,4-tolylene diisocyanate (2,4-TDI), 2,6-tolylene diisocyanate (2,6-TDI), xylylene diisocyanate (XDI), 1,5-naphthylene diisocyanate (1,5-NDI), p-phenylene diisocyanate (PPDI), and carbodiimide-modified MDI.

From the viewpoint of better wear resistance, the aromatic isocyanate preferably includes at least one selected from the group consisting of 4,4′-diphenylmethane diisocyanate, polymeric MDI, and carbodiimide-modified MDI, and more preferably includes polymeric MDI.

The content ratio of the aromatic isocyanate in the impregnation treatment agent is, for example, 10.00% by mass to 90.00% by mass, preferably 15.00% by mass to 70.00% by mass, and more preferably 20.00% by mass to 60.00% by mass.

The impregnation treatment agent may contain an aromatic isocyanate and a catalyst. As the catalyst, it is preferable to use a catalyst having uretdionization activity. That is, the cured layer preferably contains a catalyst having uretdionization activity. Furthermore, it is preferable that the cured layer be formed by impregnation with an aromatic isocyanate and a catalyst having uretdionization activity and curing.

Specific examples of the catalyst include the following: antimony pentafluoride, triethylphosphine, dibutylethylphosphine, tri-n-propylphosphine, triisopropylphosphine, tri-n-butylphosphine, triisobutylphosphine, tri-tert-butylphosphine, triamylphosphine, trioctylphosphine, tribenzylphosphine, benzylmethylphosphine, amino-substituted phosphines, imidazole, guanidine and pyridine, boron trifluoride, 1,2-dimethylimidazole, tris(N,N-dimethylamino)phosphine, tris(N,N-diethylamino)phosphine, cyclic amidines, 1,8-diazabicyclo[5.4.0]undec-7-ene, phenol salt of 1,8-diazabicyclo[5.4.0]undec-7-ene, 2-ethylhexanoate salt of 1,8-diazabicyclo[5.4.0]undec-7-ene, formate salt of 1,8-diazabicyclo[5.4.0]undec-7-ene, 4-aminopyridine, 4-dialkylaminopyridine, and the like.

The catalyst is preferably at least one selected from the group consisting of the phenol salt of 1,8-diazabicyclo[5,4,0]undec-7-ene and the 2-ethylhexanoate salt of 1,8-diazabicyclo[5,4,0]undec-7-ene.

The content ratio of the catalyst in the impregnation treatment agent is, for example, 0.01% by mass to 3.00% by mass, preferably 0.02% by mass to 1.00% by mass, and more preferably 0.02% by mass to 0.50% by mass.

The impregnation treatment agent may optionally contain a solvent. The solvent may be selected from known solvents that have low solubility for polyurethane, and is not particularly limited. Examples of the solvent include at least one organic solvent selected from the group consisting of 2-butanone, methyl isobutyl ketone, acetone, butyl acetate, ethyl acetate, and xylene.

The content ratio of the solvent in the impregnation treatment agent is, for example, 5.00% by mass to 90.00% by mass, preferably 30.00% by mass to 85.00% by mass, and more preferably 40.00% by mass to 80.00% by mass.

### Method for Producing Cleaning Blade

A method for producing the cleaning blade according to the present disclosure is not particularly limited, and a suitable method may be selected from known methods.

A method for producing the elastic member containing a polyurethane elastomer is not particularly limited, but it is preferably includes the following steps. The polyurethane elastomer composition as a urethane raw material is preferably fabricated by a prepolymer method using a prepolymer with as uniform a molecular weight distribution as possible. First, it is preferable to have a step of reacting a polyol and a polyisocyanate to obtain a prepolymer. The NCO content in the prepolymer is not particularly limited, but is preferably 3.00% by mass to 15.00% by mass, and more preferably 6.00% by mass to 10.00% by mass.

Next, a mixture of a crosslinking agent and a catalyst, and optionally a polyol and a chain extender (curing agent), is added to the obtained prepolymer, and the components are mixed to obtain a polyurethane elastomer composition. It is preferable to add a polyol to the curing agent.

After placing the support member in a mold for forming the cleaning blade, the polyurethane elastomer composition is injected into a cavity and cured by heating, thereby obtaining a cleaning blade in which the plate-shaped blade member and the support member are integrated. A known mold release agent may be applied to the mold.

Alternatively, a polyurethane elastomer sheet can be separately molded from the above polyurethane raw material composition, cut into a strip to prepare an elastic member, and then the adhesive portion of the elastic member can be superimposed on a support member coated with or adhered to an adhesive, and bonded by heating and pressing.

Next, a cured layer is formed on the polyurethane. The obtained cleaning blade comprising polyurethane is impregnated with an impregnation treatment liquid containing an aromatic isocyanate and, if necessary, a catalyst and a solvent, using a known method. For example, impregnation can be achieved by dipping the blade in a liquid mixture of isocyanate and catalyst. Alternatively, the blade may be dipped in the catalyst first and then in the isocyanate. Alternatively, the isocyanate and catalyst may be applied using a dispenser device. The isocyanate and catalyst may be diluted with a solvent.

The concentration of the catalyst relative to the isocyanate is, for example, 0.01% by mass to 3% by mass, preferably 0.05% by mass to 3% by mass, and more preferably 0.1% by mass to 2% by mass. A concentration of 0.01% by mass or more sufficiently promotes uretdionization.

After the above impregnation treatment, the aromatic isocyanate is cured to obtain a cleaning blade with a cured layer. Heating is preferably performed to cure the aromatic isocyanate. Heating promotes the impregnation of the impregnation material into the polyurethane. It also promotes uretdionization. It is preferable to cure the aromatic isocyanate by heating. The heating temperature is preferably in the range of 60° C. to 160° C. The heating time should be sufficient for the uretdionization to proceed adequately, for example, 10 min to 300 min.

### Process Cartridge and Electrophotographic Image Forming Apparatus

The cleaning blade can be incorporated and used in a process cartridge that is configured to be detachably mounted on an electrophotographic image forming apparatus. The process cartridge preferably includes a cleaning blade. Specifically, for example, in a process cartridge comprising an image bearing member as a member to be cleaned and a cleaning blade arranged to clean the surface of the image bearing member, the cleaning blade according to the present embodiment can be used as the cleaning blade. The above process cartridge contributes to the stable formation of high-quality electrophotographic images.

Furthermore, the electrophotographic image forming apparatus preferably includes a cleaning blade. The electrophotographic image forming apparatus comprises an image bearing member such as a photosensitive member and a cleaning blade arranged to clean the surface of the image bearing member, and preferably the cleaning blade is the above-mentioned cleaning blade. The above electrophotographic image forming apparatus can stably form high-quality electrophotographic images.

### EXAMPLES

The present disclosure will be described below with reference to production examples, examples, and comparative examples, but the present disclosure is not limited to these examples. Unless otherwise indicated in the examples and comparative examples, reagents or industrial chemicals were used as raw materials.

In Examples 1 to 11 and Comparative Examples 1 to 5 below, the integrally molded type cleaning blade shown in FIG. 1 was produced and evaluated. The composition of the polyurethane elastomer composition, the physical properties of the obtained elastic member, and the evaluation results for each example and comparative example are shown in Tables 1 and 2.

### Example 1

### Support Member

A 1.6 mm thick galvanized steel plate was prepared and processed to obtain a support member with an L-shaped cross-section, as shown by reference numeral 4 in FIG. 2. Furthermore, a one-component urethane-metal adhesive (product name: Chemlok 219, manufactured by Lord Corporation) was applied to the area of the support member that comes into contact with the elastic member.

### Preparation of Raw Materials for Elastic Member

### Prepolymer

Isocyanate, 4,4′-diphenylmethane diisocyanate (product name: Millionate MT, manufactured by Tosoh Corporation): 327.0 g
Polyol, butylene adipate polyester polyol with a number average molecular weight of 2500 (product name: Nippolan 3027, manufactured by Tosoh Corporation): 673.0 g

The above materials were reacted at 80° C. for 3 h to obtain a prepolymer with an NCO content of 8.80% by mass.

### Curing Agent

Hexamethylene adipate polyester polyol with a number-average molecular weight of 1000 (product name: Nippolan 3027, manufactured by Tosoh Corporation): 168.3 g
1,4-Butanediol (manufactured by Tokyo Chemical Industry Co., Ltd.): 12.9 g
Trimethylolpropane (manufactured by Tokyo Chemical Industry Co., Ltd.): 23.8 g
N,N′-dimethylhexanolamine (product name: Kaolizer No. 25, manufactured by Kao Corporation): 0.35 g
Potassium acetate (product name: POLYCAT 46, manufactured by Evonik Co., Ltd.): 0.08 g

The above materials were mixed to prepare a curing agent.

Then, a polyurethane composition A was obtained by mixing the obtained prepolymer with the curing agent.

The adhesive-coated area of the support member was arranged so as to protrude into the cavity of the molding die for the cleaning blade. Polyurethane composition A was injected into a molding die for a cleaning blade, cured at 130° C. for 5 min, and then demolded to obtain an integrally molded body of polyurethane and a support member.

The mold used was one that had been coated with release agent A before injecting the polyurethane elastomer composition. Release agent A was a mixture of 5.06 g of ELEMENT14 PDMS 1000-JC (product name, manufactured by Momentive Performance Materials Inc.), 6.19 g of ELEMENT14 PDMS 10K-JC (product name, manufactured by Momentive Performance Materials Inc.), 3.75 g of SR1000 (product name, manufactured by Momentive Performance Materials Inc.), and 85 g of EXXSOL DSP145/160.

The tip side of the polyurethane elastomer of this integrally molded body was appropriately cut to obtain a plate-shaped elastic member having a main surface and a tip surface that forms the tip edge together with the main surface. The angle of the tip edge was 90 degrees, and the distances in the short direction, thickness direction, and long direction of the elastic member were 7.5 mm, 1.8 mm, and 240 mm, respectively.

### Formation of Cured Layer

The materials shown below were prepared and mixed in the described ratios to produce an impregnation treatment agent for forming the cured layer.
4,4′-Diphenylmethane diisocyanate (product name: Millionate MT, manufactured by Tosoh Corporation): 25.00% by mass
1,8-Diazabicyclo[5.4.0]undec-7-ene phenol salt (product name: U-CAT SA1, manufactured by Sun Apro Ltd.): 0.25% by mass
2-Butanone (manufactured by Kishida Chemical Co., Ltd.) 74.75% by mass

This impregnation treatment agent for forming the cured layer was applied to the blade cut surface using a dispenser coating device “Aero Jet” (manufactured by Musashi Engineering Co., Ltd.), while moving the blade in the longitudinal direction, with a constant discharge rate, for a total of 45 mg. Then, the blade was placed in an electric furnace at a temperature of 120° C. and heat-treated for 30 min. In this way, a cleaning blade with a cured layer was obtained.

The obtained cleaning blade was evaluated by the following method.

### FT-IR Analysis of Elastic Member by ATR Method

The IR spectrum of the cured layer surface was measured by the ATR method using FT-IR.

The sample used was obtained by cutting out the elastic member of the cleaning blade from the measurement position described below.

The FT-IR measurement conditions are described below.
Apparatus: FT/IR-4700 (manufactured by JASCO Corporation)
Measurement mode: ATR method (crystal: diamond)
Number of accumulations: 64 times
Measurement position: the length of the tip edge of the cleaning blade was denoted by L, and the positions at ⅛L, ½L, and ⅞L from one end on the edge were measured.

From the obtained peak intensities, the value Ia/Ib of the peak intensity ratio of the peak intensity Ia of vC=O derived from the uretdione group to the peak intensity Ib of δNH derived from the urethane group was calculated. The arithmetic mean of this ratio is shown in Table 1.

### Evaluation of Cleaning Performance and Wear

The motor of a color laser beam printer (product name: HP Color LaserJet Enterprise 5700dn, manufactured by HP Co.) was modified to double the driving speed. A cleaning blade obtained by the method described above was incorporated into the cyan cartridge of the printer as a cleaning blade for the photosensitive member, which is the member to be cleaned. The toner in the developing unit of the cyan cartridge was completely replaced with toner 1 described hereinbelow.

Next, the printer and cartridge were moved to a low-temperature and low-humidity environment (temperature 15° C., relative humidity 10%), and 10,000 images were printed. Furthermore, the spent developing unit was replaced with a developing unit from a separately prepared cyan cartridge, and another 10,000 images were printed. This operation was repeated, resulting in a total of 50,000 images printed. After printing 50,000 images, a halftone image was output as an evaluation image, the presence or absence of image defects (streaks on the image) caused by the cleaning blade was visually checked, and image evaluation was performed.
A: No image defects occurred.
B: Image defects occurred.

In addition, the cleaning blade after printing 50,000 images was observed, and the amount of wear on the cleaning blade was evaluated by the following method.

### Method for Evaluating Wear Amount

The method for evaluating a wear amount is described below.
Equipment: Shape Measuring Laser Microscope VK-X100

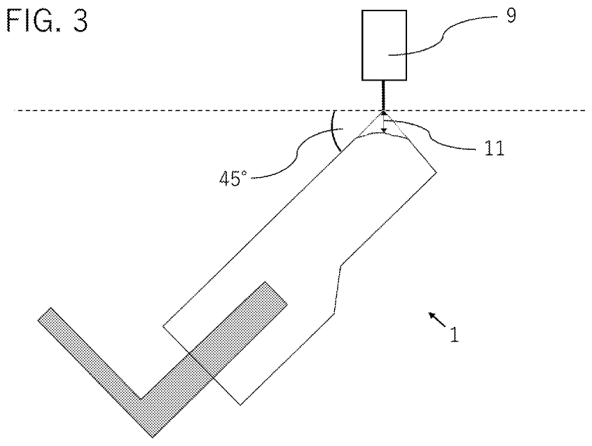

The cleaning blade was tilted at a 45° angle to a microscope 9 as shown in FIG. 3, and a height image of the tip edge was obtained. After evaluating 50,000 images, a height image of the tip edge was obtained in the same manner. The difference in the height of the tip edge before and after image evaluation was defined as a wear amount 11.

Longitudinal measurement positions: the length of the tip edge of the cleaning blade was denoted by L, and measurements were taken at positions ⅛L, ½L, and ⅞L from one end of the edge. The arithmetic mean of the wear amount 11 at these three points is shown in Table 1.

### Production Method of Toner 1

As the evaluation toner, toner 1 produced by the following method was used. In the following, “parts” are all based on mass unless otherwise specified.

### Step for Preparing Aqueous Medium 1

A total of 650.0 parts of ion-exchanged water was added to a reaction vessel equipped with a stirrer, a thermometer, and a reflux condenser, and 14.0 parts of sodium phosphate (dodecahydrate, manufactured by Rasa Industries, Ltd.) was added. The mixture was kept at 65° C. for 1.0 h while purging with nitrogen. While stirring at 15,000 rpm using a T. K. Homomixer (manufactured by Tokushu Kika Kogyo Co., Ltd.), an aqueous calcium chloride solution prepared by dissolving 9.2 parts of calcium chloride (dihydrate) in 10.0 parts of ion-exchanged water was added all at once to prepare an aqueous medium containing a dispersion stabilizer. Furthermore, 10% by mass hydrochloric acid was added to the aqueous medium to adjust the pH to 5.0, and aqueous medium 1 was obtained.

### Step for Preparing Polymerizable Monomer Composition

Styrene: 60.0 parts
C. I. Pigment Blue 15:3:6.5 parts

The above materials were charged into an attritor (manufactured by Mitsui Miike Chemical Engineering Co., Ltd.), and further dispersed using zirconia particles with a diameter of 1.7 mm at 220 rpm for 5.0 h to prepare a pigment dispersion liquid. The following materials were added to the pigment dispersion liquid.
Styrene: 20.0 parts
n-Butyl acrylate: 20.0 parts
Crosslinking agent (divinylbenzene): 0.3 parts
Saturated polyester resin: 5.0 parts

(Polycondensate of propylene oxide-modified bisphenol A (2-mole adduct) and terephthalic acid (molar ratio 10:12), glass transition temperature Tg=68° C., weight-average molecular weight Mw=10000, molecular weight distribution Mw/Mn=5.12)
Fischer-Tropsch wax (melting point 78° C.): 7.0 parts

This mixture was kept at 65° C., and a polymerizable monomer composition was prepared by uniformly dissolving and dispersing the components using T. K. Homomixer (manufactured by Tokushu Kika Kogyo Co., Ltd.) at 500 rpm.

### Granulation Step

While maintaining the temperature of aqueous medium 1 at 70° C. and the rotation speed of the T. K. Homomixer at 15000 rpm, the polymerizable monomer composition was added to aqueous medium 1, and 10.0 parts of t-butyl peroxypivalate, which is a polymerization initiator, was added. Granulation was then carried out for 10 min while maintaining 15,000 rpm with the same stirring device.

### Polymerization and Distillation Step

After the granulation step, the stirrer was replaced with a propeller stirring blade, and polymerization was carried out for 5.0 h while maintaining the temperature at 70° C. with stirring at 150 rpm. The temperature was then raised to 85° C. and heating was performed for 2.0 h to complete the polymerization reaction.

Subsequently, the reflux condenser of the reaction vessel was replaced with a cooling condenser, the slurry was heated to 100° C., and distillation was performed for 6 h to remove unreacted polymerizable monomers, thereby obtaining a toner mother particle dispersion liquid.

### Polymerization of Organosilicon Compound

In a reaction vessel equipped with a stirrer and a thermometer, 60.0 parts of ion-exchanged water was weighed, and the pH was adjusted to 4.0 using 10% by mass hydrochloric acid. This was heated while stirring, and the temperature was brought to 40° C.

Then, 40.0 parts of methyltriethoxysilane, which is an organosilicon compound, were added and stirring was conducted for 2 h or longer to perform hydrolysis. The endpoint of hydrolysis was confirmed visually by the absence of oil-water separation and the formation of a single layer. The mixture was then cooled to obtain a hydrolyzed solution of the organosilicon compound.

The temperature of the obtained toner mother particle dispersion liquid was lowered to 55° C., and then 25.0 parts of the hydrolyzed organosilicon compound solution was added to initiate the polymerization of the organosilicon compound. The reaction system was held as is for 15 min, and the pH was then adjusted to 5.5 with a 3.0% by mass sodium bicarbonate aqueous solution. After holding for 60 min while continuing stirring at 55° C., the pH was adjusted to 9.5 using a 3.0% by mass sodium bicarbonate aqueous solution, and the reaction system was further held for another 240 min to obtain a toner particle dispersion liquid.

### Washing and Drying Step

After the polymerization step was completed, the toner particle dispersion liquid was cooled, hydrochloric acid was added to the toner particle dispersion liquid to adjust the pH to 1.5 or less, and the mixture was stirred and allowed to stand for 1 h. Then, solid-liquid separation was performed using a pressure filter to obtain a toner cake. This was re-slurried with ion-exchanged water to form a dispersion liquid again, and then solid-liquid separation was performed with the aforementioned filter to obtain a toner cake.

The obtained toner cake was dried and classified in a constant temperature bath at 40° C. for 72 h to obtain toner 1.

### Examples 2 to 8

Cleaning blades were fabricated in the same manner as in Example 1, except that the materials and amounts of the impregnation treatment agent for forming the cured layer (hereinafter also simply referred to as “treatment agent”) were changed as shown in Table 1. The obtained cleaning blades were evaluated in the same manner as in Example 1. The evaluation results are shown in Table 1.

Details of the materials used other than those shown in Example 1 are shown below.
Carbodiimide-modified MDI (product name: Millionate MTL, manufactured by Tosoh Corporation)
Polymeric MDI (product name: Millionate MR-200, manufactured by Tosoh Corporation)
1,8-Diazabicyclo[5.4.0]undec-7-ene 2-ethylhexanoate (product name: U-CAT SA102, manufactured by Sun Apro Co., Ltd.)
Tributylphosphine (manufactured by Tokyo Chemical Industry Co., Ltd.)

### Example 9

The formulations of the prepolymer and curing agent were changed as follows to prepare polyurethane composition B. Otherwise, a cleaning blade was prepared in the same manner as in Example 1, and the obtained cleaning blade was evaluated in the same manner as in Example 1. The evaluation results are shown in Table 1.

### Prepolymer

Isocyanate, 4,4′-diphenylmethane diisocyanate (product name: Millionate MT, manufactured by Tosoh Corporation): 188.3 g
Isocyanate, polymeric MDI (product name: Millionate MR-200, manufactured by Tosoh Corporation): 210.0 g
Polyol, butylene adipate polyester polyol with a number-average molecular weight of 2500 (product name: Nippolan 3027, manufactured by Tosoh Corporation): 601.7 g

The above materials were reacted at 80° C. for 3 h to obtain a prepolymer with an NCO content of 10.4% by mass.

### Curing Agent

Hexamethylene adipate polyester polyol with a number-average molecular weight of 1000 (product name: Nippolan 3027, manufactured by Tosoh Corporation): 328.8 g
Trimethylolpropane (manufactured by Tokyo Chemical Industry Co., Ltd.): 58.0 g
N,N′-dimethylhexanolamine (Product name: Kaolizer No. 25, manufactured by Kao Corporation): 0.53 g
Potassium acetate (product name: POLYCAT 46, manufactured by Evonik Co., Ltd.): 0.17 g

The above materials were mixed to prepare a curing agent.

Then, a polyurethane composition B was obtained by mixing the curing agent with the obtained prepolymer.

### Example 10

The cleaning blade was dipped in the treatment agent shown in Table 1 and held for 5 min to impregnate the cleaning blade with the treatment agent. Then, the cleaning blade was immersed in butyl acetate for a few seconds to remove the treatment agent remaining on the surface, followed by air blowing.

After that, the blade was placed in an electric furnace at a temperature of 120° C. and heat-treated for 30 min. In this way, a cleaning blade with a cured layer was obtained.

The obtained cleaning blade was evaluated in the same manner as in Example 1. The evaluation results are shown in Table 1.

### Example 11

The treatment agent was divided into two parts, A and B, and a two-stage coating was performed. The treatment agent and coating method are described below.

### Treatment Agent A

1,8-Diazabicyclo[5.4.0]undec-7-ene phenol salt (product name: U-CAT SA1, manufactured by Sun Apro Co., Ltd.): 1.0% by mass
2-Butanone (manufactured by Kishida Chemical Co., Ltd.): 99.0% by mass Treatment Agent B
Polymeric MDI (product name: Millionate MR-200, manufactured by Tosoh Corporation): 25% by mass
2-Butanone (manufactured by Kishida Chemical Co., Ltd.): 75.0% by mass

These treatment agents for forming a curing layer were applied to the cleaning blade using two “Aero Jet” dispenser application devices (manufactured by Musashi Engineering Co., Ltd.). Specifically, with the first dispenser, treatment agent A was applied, for a total of 10 mg, to the blade cut surface at a constant discharge rate while moving the blade in the longitudinal direction. Then, with the second dispenser, treatment agent B was applied, for a total of 45 mg, to the blade cut surface at a constant discharge rate while moving the blade in the longitudinal direction.

After that, the blade was placed in an electric furnace at a temperature of 120° C. and heat-treated for 30 min. In this way, a cleaning blade with a cured layer was obtained.

Otherwise, a cleaning blade was fabricated in the same manner as in Example 1, and the obtained cleaning blade was evaluated in the same manner as in Example 1. The evaluation results are shown in Table 1.

### Comparative Examples 1 to 3

Cleaning blades were fabricated in the same manner as in Example 1, except for changing the materials and amounts of the treatment agents as shown in Table 1, and the obtained cleaning blades were evaluated in the same manner as in Example 1. The evaluation results are shown in Table 1.

### Comparative Examples 4 and 5

Cleaning blades were fabricated in the same manner as in Example 10, except for changing the materials and amounts of the treatment agents as shown in Table 1, and the obtained cleaning blades were evaluated in the same manner as in Example 1. The evaluation results are shown in Table 1.

TABLE 1

| | | | | Example | | | | | |
|---|---|---|---|---|---|---|---|---|---|
| | | | | 1 | 2 | 3 | 4 | 5 | 6 |
| | | | | Compo- | Compo- | Compo- | Compo- | Compo- | Compo- |
| | | | | sition | sition | sition | sition | sition | sition |
| Polyurethane composition | | | | A | A | A | A | A | A |
| Treatment | Isocyanate | Millionate | Amount | 25.00 | — | — | — | — | — |
| agent | | MT | | | | | | | |
| | | Millionate | blended | — | 25.00 | — | — | — | — |
| | | MTL | | | | | | | |
| | | Millionate | mass % | — | — | 25.00 | 25.00 | 25.00 | 50.00 |
| | | MR-200 | | | | | | | |
| | Catalyst | U-CAT | | 0.25 | — | 0.02 | 0.25 | 0.40 | 0.25 |
| | | SA1 | | | | | | | |
| | | U-CAT | | — | — | — | — | — | — |
| | | SA102 | | | | | | | |
| | | Tributyl | | — | 0.25 | — | — | — | — |
| | | phosphine- | | | | | | | |
| | Solvent | 2-Butanone | | 74.75 | 74.75 | 74.98 | 74.75 | 74.6 | 49.75 |
| Evaluation | FT-IR | la/lb | | 0.325 | 0.316 | 0.302 | 0.335 | 0.352 | 0.342 |

| | | | | | | | |
|---|---|---|---|---|---|---|---|
| Evaluation of wear | Peeling | 2.4 | 2.6 | 2.7 | 1.3 | 0.8 | 1.5 |
| | amount | | | | | | |
| | (μm) | | | | | | |

| | | | | | | |
|---|---|---|---|---|---|---|
| Evaluation surface image | A | A | A | A | A | A |

| | | | | Example | | | | |
|---|---|---|---|---|---|---|---|---|
| | | | | 7 | 8 | 9 | 10 | 11 |
| Polyurethane composition | | | | Compo- | Compo- | Compo- | Compo- | Compo- |
| | | | | sition | sition | sition | sition | sition |
| | | | | A | A | B | A | A |
| Treatment | Isocyanate | Millionate | Amount | — | — | — | — | — |
| agent | | MT | | | | | | |
| | | Millionate | blended | — | — | — | — | |
| | | MTL | | | | | | |
| | | Millionate | mass % | 25.00 | 25.00 | 25.00 | 25.00 | |
| | | MR-200 | | | | | | |
| | Catalyst | U-CAT | | — | — | 0.25 | 0.25 | |
| | | SA1 | | | | | | |
| | | U-CAT | | — | 0.25 | — | — | |
| | | SA102 | | | | | | |
| | | Tributyl | | 0.25 | — | — | — | |
| | | phosphine- | | | | | | |
| | Solvent | 2-Butanone | | 74.75 | 74.75 | 74.75 | 74.75 | |
| Evaluation | FT-IR | la/lb | | 0.338 | 0.34 | 0.334 | 0.334 | 0.337 |

| | | | | | | |
|---|---|---|---|---|---|---|
| Evaluation of wear | Peeling | 1.3 | 1.2 | 1.2 | 1.4 | 1.3 |
| | amount | | | | | |
| | (μm) | | | | | |

| | | | | | |
|---|---|---|---|---|---|
| Evaluation surface image | A | A | A | A | A |

The composition of the treatment agent in Example 11 is described in the body of the specification.

TABLE 2

| | | | | Comparative Example | | | | |
|---|---|---|---|---|---|---|---|---|
| | | | | 1 | 2 | 3 | 4 | 5 |
| Polyurethane composition | | | | Compo- | Compo- | Compo- | Compo- | Compo- |
| | | | | sition | sition | sition | sition | sition |
| | | | | A | A | A | A | A |
| Treatment | Isocyanate | Millionate | Amount | — | — | — | — | — |
| agent | | MT | | | | | | |
| | | Millionate | blended | 25.00 | — | — | 100 | — |
| | | MTL | | | | | | |
| | | Millionate | mass % | — | 25.00 | 25.00 | — | 100 |
| | | MR-200 | | | | | | |
| | Catalyst | U-CAT | | — | — | 0.01 | — | — |
| | | SA1 | | | | | | |
| | | U-CAT | | — | — | — | — | — |
| | | SA102 | | | | | | |
| | | Tributyl- | | — | — | — | — | — |
| | | phosphine | | | | | | |
| | Solvent | 2-Butanone | | 75.00 | 75.00 | 74.99 | — | — |
| Evaluation | FT-IR | la/lb | | 0.076 | 0.072 | 0.268 | 0.089 | 0.087 |

| | | | | | | |
|---|---|---|---|---|---|---|
| Evaluation of wear | Peeling | 4.1 | 5 | 3.6 | 4.6 | 4.5 |
| | amount | | | | | |
| | (μm) | | | | | |

| | | | | | |
|---|---|---|---|---|---|
| Evaluation surface image | B | B | B | B | B |

According to the present disclosure, it is possible to provide an electrophotographic cleaning blade that is resistant to wear even in high-speed systems and during long-term use, and can exhibit excellent cleaning performance for a long period of time. Furthermore, according to the present disclosure, it is possible to provide a process cartridge and an electrophotographic image forming apparatus having the above-mentioned electrophotographic cleaning blade.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-070329, filed Apr. 22, 2025, which is hereby incorporated by reference herein in its entirety.

What is claimed is:

1. An electrophotographic cleaning blade comprising an elastic member and a support member that supports the elastic member, wherein
the elastic member is composed of a polyurethane having a urethane group;
at least one surface of the elastic member has a cured layer obtained by impregnating the polyurethane with an aromatic isocyanate and curing the same;
the cured layer has uretdione group formed by uretdionization of the aromatic isocyanate, and
in FT-IR measurement of the surface of the cured layer using diamond as an ATR crystal, a value Ia/Ib of a peak intensity ratio of a peak intensity Ia of a carbonyl stretching vibration (vC=O) derived from the uretdione group to a peak intensity Ib of a NH bending vibration (δNH) derived from the urethane group is at least 0.300.

2. The electrophotographic cleaning blade according to claim 1, wherein the polyurethane has a structure formed by a reaction of at least one selected from the group consisting of 4,4′-diphenylmethane diisocyanate and polymeric MDI.

3. The electrophotographic cleaning blade according to claim 1, wherein the aromatic isocyanate is at least one selected from the group consisting of 4,4′-diphenylmethane diisocyanate, polymeric MDI, and carbodiimide-modified MDI.

4. The electrophotographic cleaning blade according to claim 1, wherein the aromatic isocyanate comprises polymeric MDI.

5. The electrophotographic cleaning blade according to claim 1, wherein the cured layer comprises a catalyst having uretdionization activity.

6. The electrophotographic cleaning blade according to claim 1, wherein the cured layer is obtained by impregnating the polyurethane with the aromatic isocyanate and a catalyst having uretdionization activity and curing the same.

7. The electrophotographic cleaning blade according to claim 1, wherein at least a part of the cured layer is a contact portion with a member to be cleaned.

8. A process cartridge comprising the electrophotographic cleaning blade comprising an elastic member and a support member that supports the elastic member, wherein
the elastic member is composed of a polyurethane having a urethane group;
at least one surface of the elastic member has a cured layer obtained by impregnating the polyurethane with an aromatic isocyanate and curing the same;
the cured layer has uretdione group formed by uretdionization of the aromatic isocyanate, and
in FT-IR measurement of the surface of the cured layer using diamond as an ATR crystal, a value Ia/Ib of a peak intensity ratio of a peak intensity Ia of a carbonyl stretching vibration (vC=O) derived from the uretdione group to a peak intensity Ib of a NH bending vibration (δNH) derived from the urethane group is at least 0.300.

9. An electrophotographic image forming apparatus comprising the electrophotographic cleaning blade comprising an elastic member and a support member that supports the elastic member, wherein
the elastic member is composed of a polyurethane having a urethane group;
at least one surface of the elastic member has a cured layer obtained by impregnating the polyurethane with an aromatic isocyanate and curing the same;
the cured layer has uretdione group formed by uretdionization of the aromatic isocyanate, and
in FT-IR measurement of the surface of the cured layer using diamond as an ATR crystal, a value Ia/Ib of a peak intensity ratio of a peak intensity Ia of a carbonyl stretching vibration (vC=O) derived from the uretdione group to a peak intensity Ib of a NH bending vibration (δNH) derived from the urethane group is at least 0.300.
